(19) United States
(12) Patent Application Publication
(10) Pub. No.: US 2005/0066027 A1
(43) Pub. Date: Mar. 24, 2005

(54) Method of displaying events

(75) Inventors: Simon R. Hakiel, Landford (GB); Paul Johnson, Fair Oak (GB)

Correspondence Address: IBM Corp;IP Law Dept T81/503, 3039 Cornwallis Road, PO Box 12195, Research Triangle Park, NC, 27709-2195, US

(73) Assignee: International Business Machines Corporation, Armonk, NY (US)

(21) Appl. No.: 10/667,581

(22) Filed: Sep. 22, 2003

(51) Int. Cl. G06F 15/173

(52) U.S. Cl. 709/224; 709/246

(57) ABSTRACT

A method of filtering one or more events associated with one or more computer environments for display in a performance monitoring system, wherein each of the one or more events is generated when a threshold associated with a first parameter is met, the method comprising the steps of: receiving a filter representing at least one of: a set of the one or more computer environments or at least one second parameter; and in response to the receiving step, filtering the one or more events.

### FIELD OF THE INVENTION

The present invention relates to a method of displaying events.

### BACKGROUND OF THE INVENTION

Computers have proliferated into all aspects of society and increasingly form the backbone of large organisations. When a computer system fails to respond as intended, businesses are invariably unable to provide even the most basic of services. Money, reputation or even lives may be lost, dependant upon the criticality of the service, the outage time etc.

In today's increasingly competitive market-place, quality is of the utmost concern. Users' expectations are high and thus the reliability of hardware/software is especially important. Customers do not tolerate mistakes and the later a defect is discovered, the more costly it can prove to the manufacturer.

Typically software developers implement a rigorous testing regime in order to ensure that a product or system is fully operational and consistently performs according to its functional specification, before it is made available to the public. Providing efficient code is an important aspect of the testing lifecycle. Just as frustrating as software that doesn't execute as expected, is software with an unacceptably poor response time.

Discovering where a piece of software spends the majority of its processing time and how effectively it uses system resources, is vital for performance fine tuning. Performance monitoring tools permit developers to measure and display software performance.

Monitoring in the broadest sense means the ability to monitor and trace performance related information (e.g. CPU times, storage usage, task activity etc.) associated with system resources (i.e. CPU, storage, tasks). Memory leakages, performance bottlenecks etc. are common problems that have to be addressed.

FIG. 1 is an overview diagram of one example of a performance monitoring system (100) comprising a client computer system (105) and a server computer system (110) comprising one or more computer environments. A server monitoring application (115) on the server computer system (110) requests information (120) associated with resources from the one or more computing environments. The server monitoring application (115) communicates this information (120) via a communication layer (135) to the client computer system (105), where it is displayed via an interface (130). If any actions are required as a result of viewing the information, an administrator at the client computer system (105) can execute them via a control interface (125).

U.S. Pat. No. 6,505,246 describes a system for presenting performance and system management data on a computer monitor. The system comprises a network, one or more presentation views, a data server, and a controller. The network interconnects a plurality of computer systems. The presentation views are defined in a memory of one of the computer systems in the network, receive commands for collecting selected performance data on the presentation view's associated computer system, and collect and present the selected performance data. The data server is executed by one of the computer systems in the network, generates requests for the selected performance data, and stores the collected selected performance data returned in response to the requests. The controller is executed by one of the computer systems in the network, translates the requests generated by the data server into the commands for the presentation views, transmits the commands to the presentation views, and forwards the collected performance data to the data server for storage.

If an administrator is monitoring several environments, it can be difficult and time-consuming in current performance monitoring systems to “drill” down to a given piece of performance related information. Thus, there is a need to improve the interface of performance monitoring systems.

### SUMMARY OF THE INVENTION

According to a first aspect, the present invention provides a method of filtering one or more events associated with one or more computer environments for display in a performance monitoring system, wherein each of the one or more events is generated when a threshold associated with a first parameter is met, the method comprising the steps of: receiving a filter representing at least one of: a set of the one or more computer environments or at least one second parameter; and in response to the receiving step, filtering the one or more events. An example of the first parameter is severity level and an example of the threshold is above low. An example of the second parameter is resource. Another example of the second parameter is time. Another example of the second parameter is an identifier associated with each of the one or more events.

Preferably, the method further comprising the step of displaying the filtered one or more events. Preferably, the filter is received from and the one or more filtered events are displayed on, a single display window. Advantageously, this provides the administrator with a simple view of the data, via a single point of access.

In a preferred embodiment, for each of the filtered one or more events, the displaying step further comprises the step of displaying a first set of information associated with an event identifier (e.g. A unique number); an identifier associated with the one or more computer environments; the first parameter (e.g. The threshold associated with the first parameter); the second parameter (e.g. The type of resource—file, memory, CPU etc.); and a second parameter identifier.

Preferably, the first set of information is associated with a second set of information, such as information associated with the configuration of the one or more computer environments or information associated with the threshold. Advantageously, this second set of information may aid problem determination or performance tuning. Preferably, each of the one or more computer environments comprises at least one computer system.

According to a second aspect, the present invention provides an apparatus for filtering one or more events associated with one or more computer environments for display in a performance monitoring system, wherein each of the one or more events is generated when a threshold associated with a first parameter is met, the apparatus comprising: means for receiving a filter representing at least one of: a set of the one or more computer environments or at least one second parameter; and means, responsive to the receiving means, for filtering the one or more events.

According to a third aspect, the present invention provides a computer program product tangibly embodied in a computer readable medium to, when loaded into a computer system and executed, cause said computer to perform the steps of the method as described above.

### BRIEF DESCRIPTION OF THE DRAWINGS

The present invention will now be described, by way of example only, with reference to preferred embodiments thereof, as illustrated in the following drawings:

FIG. 1 is an overview diagram of one example of a performance monitoring system in which the present invention may be implemented;

FIG. 2 is an overview of the computing environments in the system of FIG. 1;

FIG. 3 is a flow chart showing the operational steps involved in one example of a filtering process;

FIG. 4A shows an interface displaying events associated with the computing environments in FIG. 2;

FIG. 4B shows an interface displaying filtered events associated with a set of the computing environments in FIG. 2;

FIG. 5 is a representation of a means for selecting at least one parameter filter; and

FIG. 6 shows an interface displaying filtered events associated with the at least one parameter filter that has been selected.

### DETAILED DESCRIPTION OF THE INVENTION

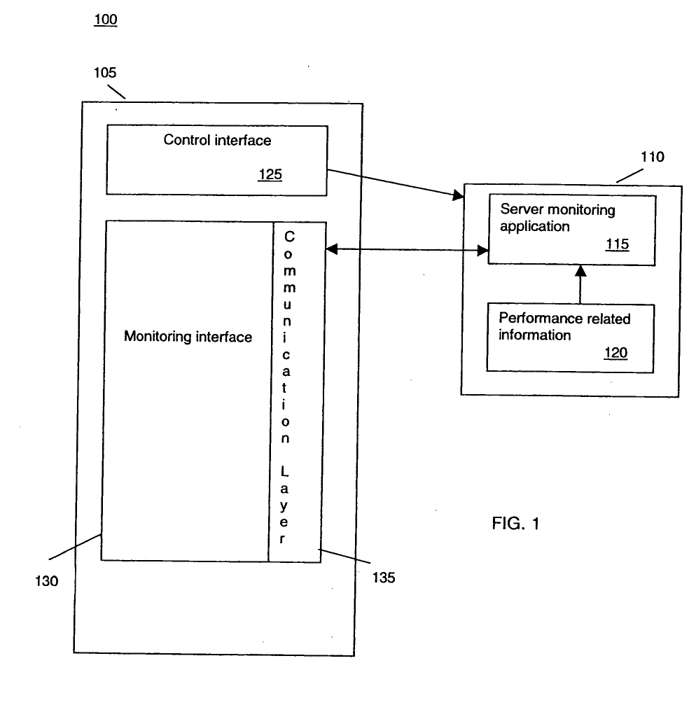

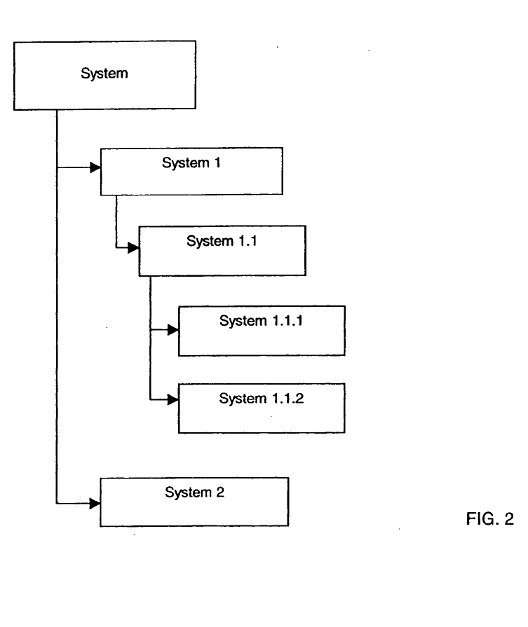

Preferred embodiments of the present invention will now be described. With reference to the performance monitoring system (100) of FIG. 1, the server computer system (110) comprises one or more computer environments. In FIG. 2, the one or more computer environments comprises a plurality of systems (e.g. application servers) (System 1 and System 2) and sub-systems (System 1.1, System 1.1.1 and System 1.1.2). It should be understood that the systems and sub-systems can run the same programs or can run different programs. It should be understood that the systems and sub-systems can run across more than one server computer system.

Although the examples herein describe systems to be monitored, it should be understood that any other type of environment can be monitored. For example, a computer environment can comprise one or more groups of systems, wherein each group comprises at least one system. Furthermore, although virtual systems have been described herein, it should be understood that the environments can also comprise physical computer systems.

A server monitoring application (115) located on the server computer system (110) requests one or more “events” (120) from the plurality of computer environments. Events are associated with one or more resources (e.g. A file, memory etc.) in the computer environments and are generated for display, when a specified threshold for a first parameter in a computing environment(s) is triggered. One example of a first parameter is a severity level associated with an event. Another example of a first parameter is an attribute associated with a resource (e.g. Wherein the attribute is a representation of state—“enabled”, “disabled”, “connected”, “not connected” etc.). In one embodiment, a means for specifying the threshold is provided to the administrator. However, it should be understood that the threshold can be specified in any other way (e.g. By a computer program).

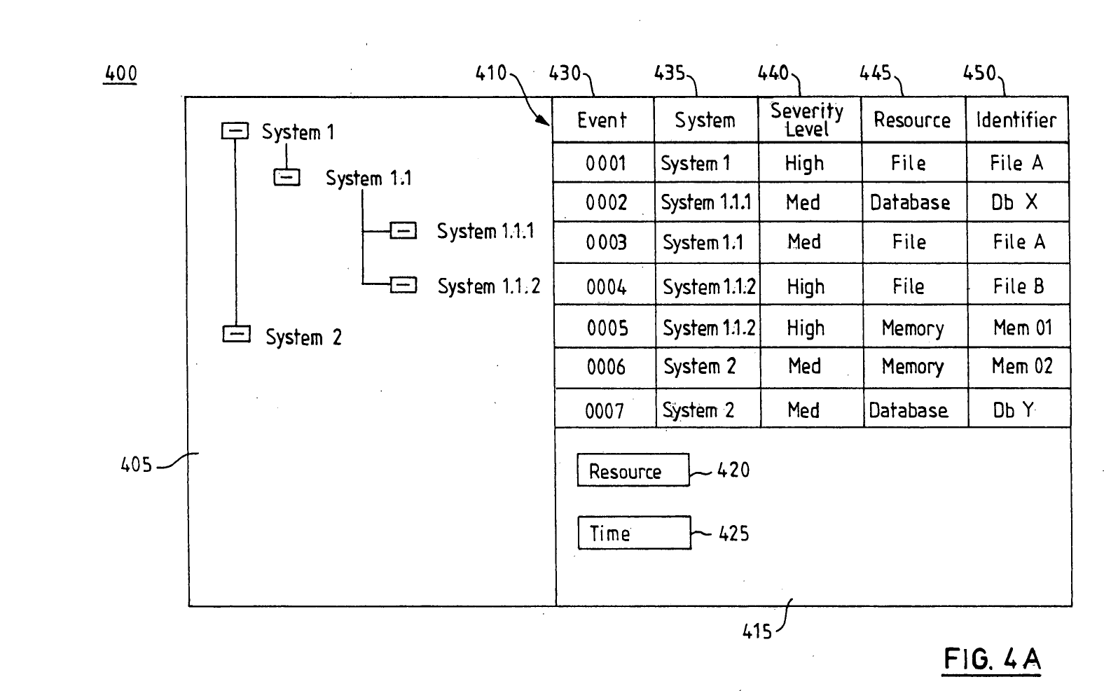

In one example, a threshold for severity level (i.e. above low) is defined and an event is only generated if the severity level meets the threshold (i.e. If the severity level is medium or high). With reference to FIG. 4A, an example of the resulting performance monitoring interface is shown wherein the left pane (405) shows the computer environments, the upper right pane (410) shows information associated with: an identifier associated with an event (430) (i.e. 0001-0007); an identifier that identifies the system (435) on which those events are occurring (i.e. System 1, System 1.1, System 1.1.1, System 1.1.2, System 2); the severity level (440) (i.e. medium or high); the resource (445) (i.e. file, database or memory) and an identifier associated with the resource (450) (i.e. File A, DbX, File B, Mem01, Mem02, DbY).

The server monitoring application (115) communicates this information (120) via a communication layer (135) to the client computer system (105), where it is displayed via an interface (130). If any actions are required as a result of viewing the events, an administrator at the client computer system (105) can execute them via a control interface (125).

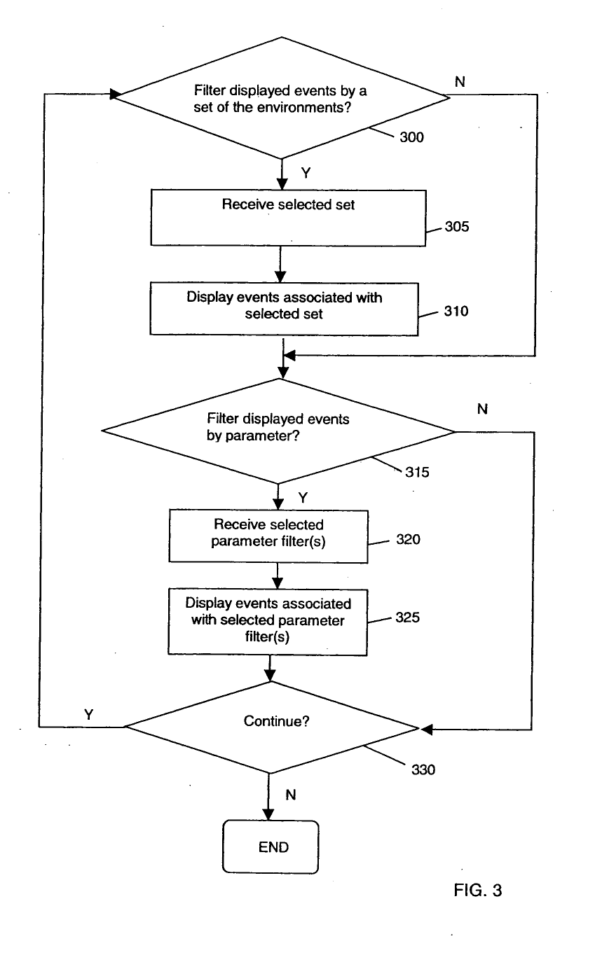

FIG. 3 is a flow chart showing the operational steps involved in a preferred embodiment of the present invention which will now be described, in conjunction with FIGS. 4B-6.

Generally, the events are filtered for display in a performance monitoring system, by a filter representing at least one of: a set (i.e. the scope) of the one or more environments or a second parameter (e.g. Resource, time, name/number of event etc.).

In step 300, a determination is made as to whether a filter representing a set of the one or more environments (referred to herein as a set filter), is to be applied to the events that are displayed, in order to constrain the events displayed. In response to a negative result to step 300, the process passes to step 315 (described below). In response to a positive result to step 300, the process passes to step 305, wherein an input comprising the selected filter(s) is received and in response to this, the events are filtered (step 310) for display. Advantageously, the input comprising the selected set filter is received from and the events are displayed on, a single display window and this provides the administrator with a simple view of the data, via a single point of access.

An example is now described. In FIG. 2, the computing environments are arranged in a hierarchy. It should be understood that the set can comprise all of the environments (i.e. System 1, all sub-systems and System 2), some or all of the environments at a first level (i.e. System 1, System 2), or some or all of the environments at any other level (i.e. System 1.1, System 1.1.1, System 1.1.2).

In this example, the administrator selects a set comprising System 1 and all associated sub-systems (i.e. System 1.1, System 1.1.1, System 1.1.2). FIG. 4B depicts the resulting interface (400), which shows System 1 highlighted within a bold box in the left pane (405). In response to selection of the set, one or more events associated with one or more resources of the one or more computing environments in the set, are displayed. In this example, a threshold of severity level (i.e. above “low”) has been specified against all resources (i.e. files, databases, memory etc.)—any resulting events in the selected set that are generated are displayed. The upper right pane (410) shows a first set of information associated with: an identifier associated with an event (430) (i.e. 0001-0005); an identifier that identifies the systems (435) on which those events are occurring (i.e. System 1, System 1.1, System 1.1.1, System 1.1.2); the severity level (440) (i.e. medium or high); the type of resource (445) (i.e. file, database or memory) and an identifier associated with the resource (450) (i.e. File A, DbX, File B, Mem01).

It should be understood that the set of the computing environments can be changed. For example, in order to display events occurring on System 2, the administrator selects System 2 in the left pane (405). Therefore, advantageously, rather than having to load successive pages to monitor events on various environments, the administrator can monitor various environments via a single point of access. This is advantageous, for example, when monitoring large enterprises. It should be understood that the set can be selected in any other way (e.g. via a dialog box).

Next, the process passes to step 315, where a determination is made as to whether a filter associated with at least one parameter (referred to herein as a “parameter filter”) has been applied to the events that are displayed. With reference to FIG. 4B, buttons (420, 425) representing the available parameter filters are presented to the administrator so that the administrator can then select at least one of the buttons.

In response to a negative result to step 315, the process passes to step 330 where a determination is made as to whether the process is to continue. In response to a positive result to step 330, the process passes to step 300. In response to a negative result to step 330, the process ends.

In response to a positive result to step 315, an input comprising the selected parameter filter(s) is received (step 320) and in response to this, the events are filtered (step 325) for display. Advantageously, the input comprising the selected parameter filter is received from and the events are displayed on, a single display window and this provides the administrator with a simple view of the data, via a single point of access.

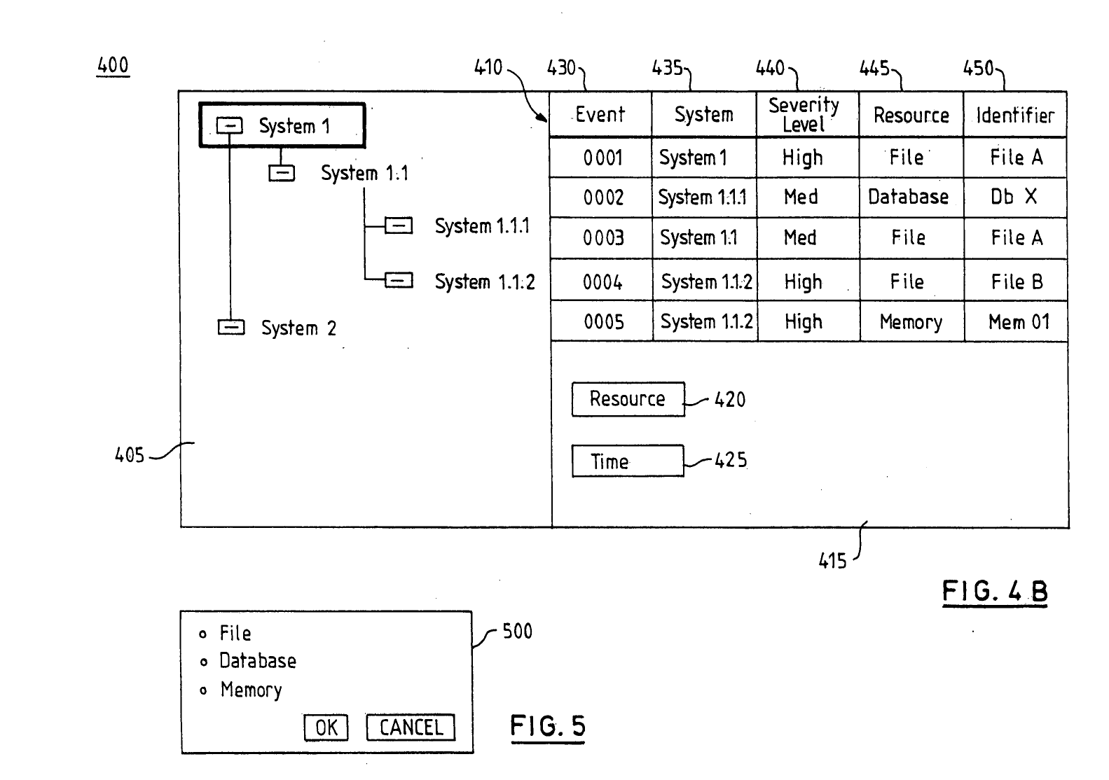

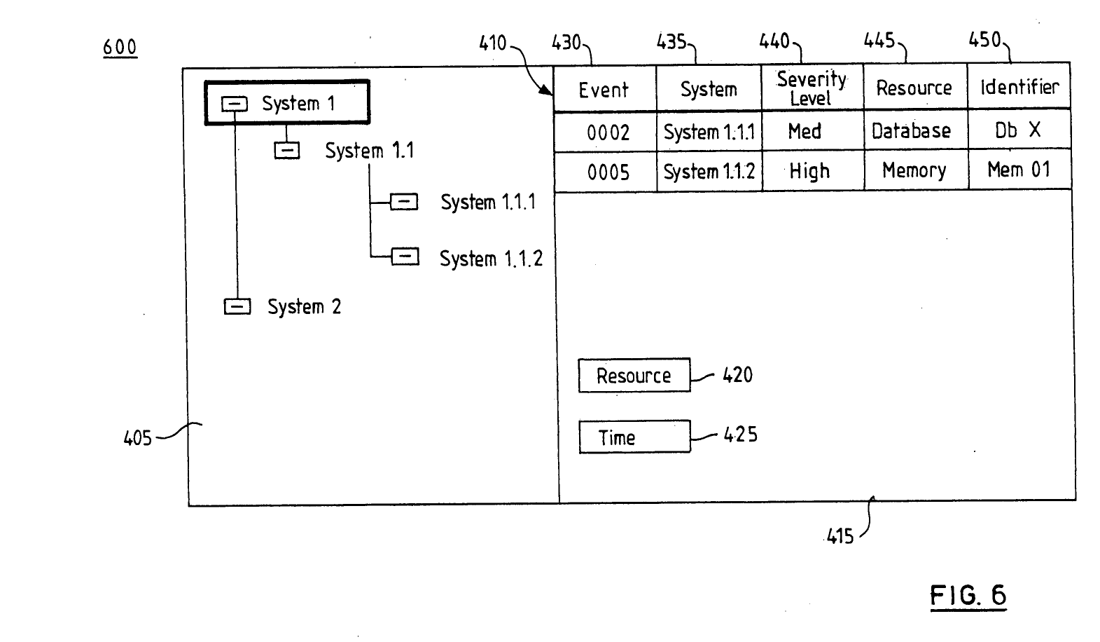

In a first example, the administrator selects button 420 (representing “Resources”) and in response to this, a dialog box (500) comprising the parameter filter options (shown in FIG. 5) is presented to the user. Alternatively the parameter filter options can be displayed in interface 400 itself. Next, the administrator selects buttons representing “Database” and “Memory”. In response to the selection, the selection input is received and the selected parameter filters are applied to the events. The resulting interface (600) is shown in FIG. 6, wherein only the events (i.e. 0002 and 0005) associated with the selected parameter filters are displayed. Thus it should be understood that the application of a parameter filter(s) limits the events displayed in an interface to those relating to that parameter filter(s) (and in this example, for the currently selected set of computing environments).

In a second example, the administrator selects button 425 (representing “Time”) and in response to this, the administrator is provided with parameter filter options (not shown) representing time periods (e.g. the last five minutes, the last ten minutes, the next five minutes etc.). When the selected parameter filter option(s) is applied, the administrator is provided with a view of event(s) that have occurred or are to occur within the selected time period (e.g. the last five minutes). This parameter filter can therefore provide the administrator with a historical view of the events.

It should be understood, that although the parameter filters have been described as being applied exclusively to each other (i.e. Resource or Time), in an alternative embodiment, the parameter filters can be applied non-exclusively (i.e. firstly by Resource and then by Time (or vice versa)). It should be understood that although parameter filters representing resource and time have been described, any other parameter filter that acts as a constraint on the events displayed can be implemented. Also, although the set and parameter filters have been described as being applied non-exclusively to each other (i.e. firstly by set and then by parameter) in an alternative embodiment, the set and parameter filters can be applied exclusively to each other. In an alternative embodiment, the filters can be applied before the events are displayed for the first time—in this embodiment, advantageously, the process of displaying to the administrator the information that they require is quicker.

Next, the process passes to step 330 where a determination is made as to whether the process is to continue. In response to a positive result to step 330, the process passes to step 300. In response to a negative result to step 330, the process ends.

In a preferred embodiment, means for accessing a second set of information associated with the first set of information is provided. For example, with reference to FIG. 4B, by selecting items in the upper right pane (410), a second set of information is displayed. For example, by selecting an event that is displayed (e.g. by double clicking on a link associated with event “0001”), the administrator is taken to another interface comprising further information related to that event (e.g. information related to the threshold that has been defined for that event—i.e. a threshold of severity level of above “low”). Alternatively, the further information can be displayed in the same interface (400).

In another example, by selecting an environment (e.g. by double clicking on a link associated with “System 1”), information relating to that environment is displayed (e.g. software configuration, hardware configuration etc.). In another example, by selecting a resource (e.g. by double clicking on a link associated with “File”), information relating to that resource is displayed (e.g. the specific files (File A and File B). Generally, the second set of information, may aid problem determination or performance tuning.

It should be understood that although the preferred embodiment has been described within a networked client-server environment, the present invention could be implemented in any environment. For example, the present invention could be implemented in a stand-alone environment.

The present invention is preferably embodied as a computer program product for use with a computer system. Such an implementation may comprise a series of computer readable instructions either fixed on a tangible medium, such as a computer readable media, e.g., diskette, CD-ROM, ROM, or hard disk, or transmittable to a computer system, via a modem or other interface device, over either a tangible medium, including but not limited to optical or analog communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable media with accompanying printed or electronic documentation, e.g., shrink wrapped software, pre-loaded with a computer system, e.g., on a system ROM or fixed disk, or distributed from a server or electronic bulletin board over a network, e.g., the Internet or World Wide Web.

1. A method of filtering one or more events associated with one or more computer environments for display in a performance monitoring system, wherein each of the one or more events is generated when a threshold associated with a first parameter is met, the method comprising the steps of:
receiving a filter representing at least one of: a set of the one or more computer environments or at least one second parameter; and
in response to the receiving step, filtering the one or more events.

2. A method as claimed in claim 1, further comprising the step of displaying the filtered one or more events.

3. A method as claimed in claim 2, wherein the filter is received from and the one or more filtered events are displayed on, a single display window.

4. A method as claimed in claim 2, wherein for each of the filtered one or more events, the displaying step further comprises the step of displaying a first set of information associated with: an event identifier; the associated one or more computer environments; the first parameter; the second parameter; and a second parameter identifier.

5. A method as claimed in claim 4, wherein the first set of information is associated with a second set of information.

6. A method as claimed in claim 5, wherein the second set of information comprises information associated with the configuration of the one or more computer environments.

7. A method as claimed in claim 5, wherein the second set of information comprises information associated with the threshold.

8. A method as claimed in claim 1, wherein the first parameter represents a severity level.

9. A method as claimed in claim 1, wherein the second parameter represents a resource.

10. A method as claimed in claim 1, wherein the second parameter represents a time.

11. A method as claimed in claim 1, wherein each of the one or more computer environments comprises at least one computer system.

12. An apparatus for filtering one or more events associated with one or more computer environments for display in a performance monitoring system, wherein each of the one or more events is generated when a threshold associated with a first parameter is met, the apparatus comprising:
means for receiving a filter representing at least one of: a set of the one or more computer environments or at least one second parameter; and
means, responsive to the receiving means, for filtering the one or more events.

13. A computer program product tangibly embodied in a computer readable medium to, when loaded into a computer system and executed, cause said computer to perform the steps of claim 1.
